(19) United States
(12) Patent Application Publication
(10) Pub. No.: US 2014/0320637 A1
(43) Pub. Date: Oct. 30, 2014

(54) VEHICULAR IMAGE PROCESSING APPARATUS AND METHOD OF PROVIDING INFORMATION USING THE VEHICULAR IMAGE PROCESSING APPARATUS

(71) Applicants: THINKWARE SYSTEMS CORPORATION, Seongnam-si (KR); INTELLECTUAL DISCOVERY CO., LTD., Seoul (KR)

(72) Inventor: Chang Soung YI, Seongnam-si (KR)

(73) Assignees: INTELLECTUAL DISCOVERY CO., LTD., Seoul (KR); THINKWARE SYSTEMS CORPORATION, Seongnam-si (KR)

(21) Appl. No.: 14/263,274

(22) Filed: Apr. 28, 2014

(30) Foreign Application Priority Data
Apr. 29, 2013 (KR) 10-2013-0047790

(51) Int. Cl. G06K 9/00; B60R 1/00; G08G 1/16; H04N 7/18

(52) U.S. Cl. CPC G06K 9/00805; H04N 7/18; G06K 9/00798; B60R 1/00; G08G 1/16
USPC 348/118

(57) ABSTRACT

Provided are a vehicular image processing apparatus that may prevent an accident by recognizing, using a black box for a vehicle, a dangerous situation through image recognition and by warning a driver of the vehicle and a driver of another vehicle corresponding to a counterparty vehicle about a probable accident to avoid the accident, and a method of providing information using the vehicular image processing apparatus.

### CROSS-REFERENCE TO RELATED APPLICATION

This application claims the priority benefit of Korean Patent Application No. 10-2013-0047790, filed on Apr. 29, 2013, in the Korean Intellectual Property Office, the disclosure of which is incorporated herein by reference.

### BACKGROUND

1. Field of the Invention

The present invention relates to a vehicular image processing apparatus, and more particularly, to a vehicular image processing apparatus that may prevent an accident by recognizing a dangerous situation through image recognition and by warning a driver of a corresponding vehicle and a driver of another vehicle corresponding to a counterparty vehicle about the recognized dangerous situation, and an image processing method using the vehicular image processing apparatus.

2. Description of the Related Art

Currently, to readily investigate the cause of traffic accident and to minimize the dispute between parties involved in the traffic accident, an increasing number of vehicle owners install a black box in a vehicle. In this regard, mandatory installation of a black box in a vehicle is recommended in many countries.

A currently commercialized black box provides a function of warning a dangerous situation, such as detecting an obstacle and warning a lane departure. However, detecting a lane departure alone may not prevent an accident between a corresponding vehicle and another vehicle corresponding to a counterparty vehicle and detecting an obstacle may warn only a driver of the corresponding vehicle and thus, only a passive avoidance is possible. Accordingly, the driver of the corresponding vehicle may defensively drive the vehicle by being informed of a dangerous situation, but may not determine a travelling direction of the other vehicle and thus, the risk of traffic accident still remains.

### SUMMARY

An aspect of the present invention provides a vehicular image processing apparatus that may prevent an accident by recognizing, using a black box for a vehicle, a dangerous situation through image recognition and by warning a driver of the vehicle and a driver of another vehicle corresponding to a counterparty vehicle about a probable accident to avoid the accident, and a method of providing information using the vehicular image processing apparatus.

According to an aspect of the present invention, there is provided a vehicular image processing apparatus mountable in a vehicle, the vehicular image processing apparatus including: a camera module configured to acquire an external image; and a controller configured to analyze the external image, and to transmit a danger signal to an outside of the vehicle when a danger associated with a predetermined object present outside the vehicle is determined to be present.

The controller may determine whether the danger associated with the predetermined object is present, based on a result of recognizing a lane included in the external image.

The controller may recognize, from the external image, at least one of a left lane, a right lane, and a horizontal line of a road ahead that connects the left lane and the right lane.

The controller may determine whether the predetermined object is to enter ahead of the vehicle, based on whether at least one of the left lane, the right lane, and the horizontal lane recognized from the external image is occluded by a first object corresponding to the predetermined object.

The controller may determine a distance between the predetermined object and the vehicle when the predetermined object is determined to enter ahead of the vehicle.

The controller may determine that the danger associated with the predetermined object is present when the distance between the predetermined object and the vehicle is less than a predetermined threshold.

The controller may determine an approaching direction of the predetermined object, and may determine whether the danger associated with the predetermined object is present based on the determined approaching direction of the predetermined object and the distance between the predetermined object and the vehicle.

The controller may determine whether the danger associated with the predetermined object is present by recognizing whether the predetermined object included in the external image is approaching the vehicle.

The vehicular image processing apparatus may further include a communication unit configured to communicate with the predetermined object. The controller may control the communication unit to transmit the danger signal to the predetermined object.

The controller may analyze location information of the vehicle and a location of the predetermined object determined from the external image, and may control the communication unit to transmit the location information and a communication connection request signal to the outside.

The controller may control the communication unit to transmit, to the outside, a communication connection request signal and identification information of the predetermined object determined from the external image.

The controller may transmit the danger signal to a plurality of objects present around the vehicle.

The vehicular image processing apparatus may further include a warning unit configured to indicate the danger signal inside the vehicle.

The danger signal may include at least one of a warning signal, a lighting tool, and a sound output that is transmitted to the predetermined object or a peripheral vehicle of the vehicle.

The controller may receive information on at least one object present around the vehicle through an infrastructure provided around a road, and may transmit the danger signal to the at least one object based on the received information.

According to another aspect of the present invention, there is provided a method of providing information using a vehicular image processing apparatus mountable in a vehicle, the method including: acquiring an external image about an outside of the vehicle; determining whether a danger associated with a predetermined object present outside the vehicle is present by analyzing the external image; and transmitting a danger signal to the outside of the vehicle when the danger associated with the predetermined object is determined to be present.

The determining may include determining whether the danger associated with the predetermined object is present by recognizing a lane included in the external image.

The determining may include determining whether the danger associated with the predetermined object is present by recognizing whether the predetermined object included in the external image is approaching the vehicle.

The transmitting may include transmitting the danger signal to a plurality of objects present around the vehicle.

The transmitting may include receiving information on the plurality of objects through an infrastructure provided around a road, and transmitting the danger signal to the plurality of objects based on the received information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a vehicular image processing apparatus according to an embodiment of the present invention.

FIG. 2 is a block diagram illustrating a vehicular image processing system according to an embodiment of the present invention.

FIG. 3 is a flowchart illustrating a method of providing information according to an embodiment of the present invention.

FIG. 4 is a flowchart illustrating a method of providing information according to another embodiment of the present invention.

FIG. 5 illustrates an example of applying image recognition according to an embodiment of the present invention.

FIG. 6 is a flowchart illustrating a method of providing information according to still another embodiment of the present invention.

FIG. 7 is a diagram illustrating an infrastructure based warning scheme according to an embodiment of the present invention.

FIG. 8 is a diagram illustrating a vehicle-to-vehicle communication based warning scheme according to an embodiment of the present invention.

### DETAILED DESCRIPTION

Reference will now be made in detail to exemplary embodiments of the present invention, examples of which are illustrated in the accompanying drawings, wherein like reference numerals refer to like elements throughout. Exemplary embodiments are described below to explain the present invention by referring to the figures.

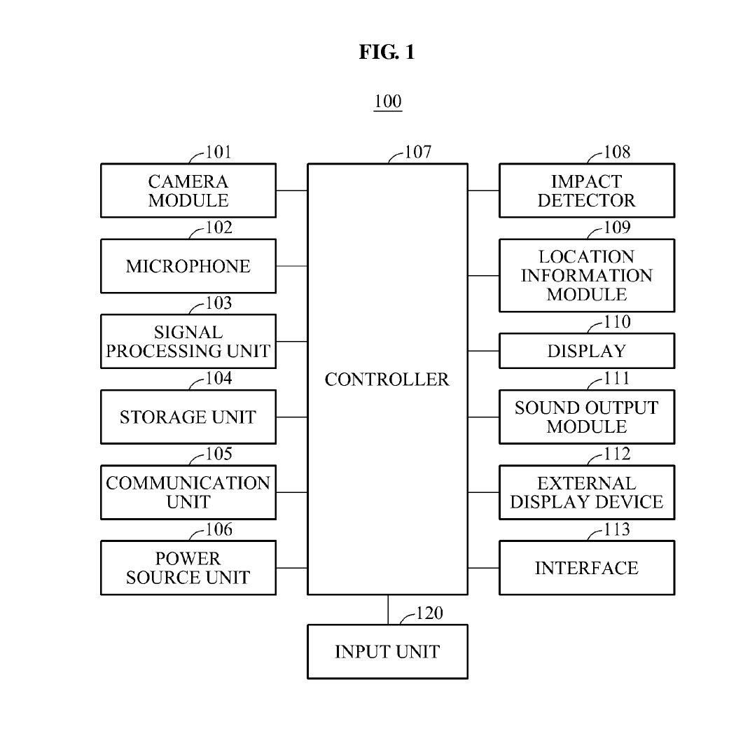

FIG. 1 is a block diagram illustrating a configuration of a vehicular image processing apparatus 100 according to an embodiment of the present invention.

The vehicular image processing apparatus 100 may also be referred to as a black box apparatus for a vehicle.

Referring to FIG. 1, the vehicular image processing apparatus 100 may include a camera module 101, a microphone 102, a signal processing unit 103, a storage unit 104, a communication unit 105, a power source unit 106, a controller 107, an impact detector 108, a location information module 109, a display 110, a sound output module 111, an external display device 112, an interface 113, and an input unit 120.

The camera module 101 may capture an image at the front, rear, side, and interior of a vehicle, and may transmit the captured image to the signal processing unit 103. The captured image may be compressed by the signal processing unit 103 and stored in the storage unit 104, or may be immediately stored in the storage unit 104 without passing through a compression process. Based on a system configuration, the camera module 101 may include a single camera to capture an image only at the front of the vehicle, or may include a plurality of cameras. In the second case, recording locations of the cameras may be variously set at the front, rear, side, or interior of the vehicle using a variety of methods, based on a purpose.

The microphone 102 may record sound originating from outside or inside of the vehicle, and may transmit the recorded sound to the signal processing unit 103. Here, the sound may include voice, noise, and the like. The recorded sound may be transmitted to the signal processing unit 103 and may be stored in the storage unit 104 through a compression process at the signal processing unit 103, or may be immediately stored in the storage unit 104 without passing through the compression process. The recorded sound may relate to sound occurring due to an external impact or a situation occurring internally and externally. The recorded sound and the captured image may be helpful in recognizing conditions at the time of accident.

The signal processing unit 103 may compress the image captured by the camera module 101 to decrease a volume of image data. Image data may be provided in a form in which a plurality of frames is gathered based on a time axis. For example, the image data may be successive pictures captured during a given period of time. In a case in which a volume of such images capacity may be overly great without being compressed, storing the original images may be inefficient and thus, compression may be performed on digitally converted images. A video may be compressed by employing a method using a characteristic of a vision sensitive to a low frequency component, a correlation between frames, and a spatial correlation. Original data may be lost due to compression and thus, needs to be compressed at a predetermined ratio at which conditions related to a vehicle at a time of traffic accident is verifiable. A video may be compressed using one of various video codecs, for example, H.264, moving picture experts group (MPEG)-4, H.263, and H.265/high efficiency video coding (HEVC. Image data may be compressed using a method supported by the vehicular image processing apparatus 100.

The signal processing unit 103 may compress data recorded by the microphone 102. The signal processing unit 103 may compress and encrypt the recorded image and voice data to restrict an access to data.

The storage unit 104 may store the recorded image and sound data as a single file or two files, based on a storage interval unit. For example, if a storage interval is 30 seconds, an image and sound recorded during the first 30 seconds may be compressed and stored as a video file, and an image and sound recorded during another 30 seconds may be compressed and stored. The above process may be repeated.

The storage unit 104 may store different items of data in divided storage areas, based on a recording mode. For example, data recorded during driving and data recorded during parking may be stored in different distinguishable folders. Data recorded at all times and data recorded by an event may be stored in different distinguishable folders.

The storage unit 104 may be provided within the vehicular image processing apparatus 100, may be provided to be detachable through a port provided in the vehicular image processing apparatus 100, or may be provided outside the vehicular image processing apparatus 100. In a case in which the storage unit 104 is provided within the vehicular image processing apparatus 100, the storage unit 104 may be provided in a form of a hard disk drive (HDD) or a flash memory. In a case in which the storage 104 is provided to be detachable to the vehicular image processing apparatus 100, the storage unit 104 may be provided in a form of a secure digital (SD) card, a micro SD card, or a universal serial bus (USB) memory. In a case in which the storage unit 104 is provided outside the vehicular image processing apparatus 100, the storage unit 104 may be present in another device or a storage space of a server through the communication unit 105.

The communication unit 105 may configure a connection between the vehicular image processing apparatus 100 and a server, another vehicle, or another device to exchange a recorded image or sound. In addition, the communication unit 105 may enable vehicle information or peripheral information to be transmitted to and received from the server, the other vehicle, or the other device. The communication unit 105 may support wireless networks, for example, wireless fidelity (Wi-Fi), Bluetooth, 3^{rd} generation (3G), long term evolution (LTE), world interoperability for microwave access (WiMax), and wireless gigabit alliance (WiGig), or wired networks, for example, Ethernet and a modulator-demodulator (MODEM).

The power source unit 106 may receive power from an external power source or an internal battery, and may supply operational power to the vehicular image processing apparatus 100. In a state in which the vehicle is started, the power of the vehicle may be applied to the vehicular image processing apparatus 100 to charge a chargeable battery thereof. In a state in which the vehicle is stalled, the power of the rechargeable battery may be supplied to the vehicular image processing apparatus 100.

The controller 107 may generally control the overall operation of the vehicular image processing apparatus 100. The controller 107 may include a multimedia module to play back multimedia. The multimedia module may be configured within the controller 107 and may also be configured to be separate from the controller 107.

The controller 107 may set an operating mode of the vehicular image processing apparatus 100 based on whether the vehicle is travelling, that is, being driven or a signal of the impact detector 108. While the vehicle is travelling, the controller 107 may perform an ordinary recording function or may perform an event recording function in response to an impact event detected by the impact detector 108. While the vehicle is being parked, the controller 107 may control the vehicular image processing apparatus 100 to perform a parking recording function by determining the impact event detected by the impact detector 108 or a movement of an object recorded in the camera module 101.

When a level of impact applied to the vehicle is detected or when a change in acceleration is greater than or equal to a predetermined level, the impact detector 108 may generate a signal corresponding to an event, for example, an accident event occurring with respect to the vehicle, and may transmit the generated signal to the controller 107. The impact detector 108 may include an acceleration sensor and an earth magnetic field sensor to detect impact or acceleration.

The location information module 109 refers to a module to verify or obtain a location of the vehicular image processing apparatus 100. A representative example of the location information module 109 may include a global positioning system (GPS) module.

The location information module 109 may continuously calculate a current location of the vehicle in runtime, and may calculate speed information of the vehicle based on calculated locations.

The display 110 may display or output information processed by the vehicular image processing apparatus 100.

For example, the display 110 may display an image and sound recorded by the camera module 101 in runtime or at a desired time, and may display recording settings on a screen to be easily set by the controller 107. Further, a touch input is possible on the display 110 and thus, a user may readily select and set a desired function on the display 110.

The display 110 may include at least one of a liquid crystal display (LCD), a thin film transistor (TFT) LCD, an organic light emitting diode (OLED) display, a flexible display, and a three-dimensional (3D) display.

In a case in which the display 110 and a sensor (hereinafter, a touch sensor) configured to sense a touch motion are configured in a mutual layer structure (hereinafter, a touch screen), the display 110 may be employed as an input device in addition to an output device. The touch sensor may be provided in a form of, for example, a touch film, a touch sheet, and a touch pad.

The sound output module 111 may output audio data that is received by the communication unit 105 or stored in the storage unit 104. The sound output module 111 may output an audio signal related to a function performed by the vehicular image processing apparatus 100.

The sound output module 111 may include a receiver, a speaker, and a buzzer. Also, the sound output module 111 may output sound through an earphone jack. The user may listen to the sound being output by connecting an earphone to the earphone jack.

The external display device 112 refers to a light emitting device, for example, an LED and a light, and may inform an operating state of the vehicular image processing apparatus 100, or may provide light for an easy control of the vehicular image processing apparatus, for example, a button or a touch.

The interface 113 may act as a passage between the vehicular image processing apparatus 100 and all the external devices connected to the vehicular image processing apparatus 100. The interface 113 may receive data or power from an external device and may transfer the data or the power to each constituent element of the vehicular image processing apparatus 100, or may enable internal data of the vehicular image processing apparatus 100 to be transmitted to an external device. For example, the interface 113 may include a wired/wireless headset port, an external charger port, a wired/wireless data port, a memory card port, a port configured to connect a device including an identification module, an audio input/output (I/O) port, a video I/O port, and an earphone port.

Using the input unit 120, a user may generate input data to control an operation of the vehicular image processing apparatus 100. The input unit 120 may include a key pad, a dome switch, a capacitive or resistive touch pad, a jog wheel, and a jog switch.

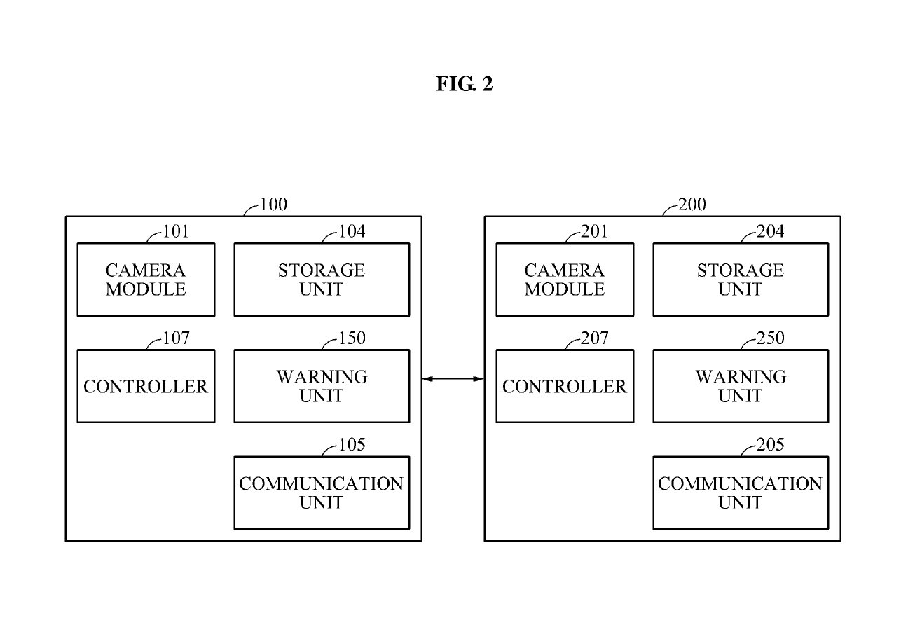

FIG. 2 is a block diagram illustrating a vehicular image processing system according to an embodiment of the present invention.

Referring to FIG. 2, the vehicular image processing apparatus may include the vehicular image processing apparatus 100 (hereinafter, also referred to as a vehicle A black box 100) mounted in a vehicle A and a vehicular image processing apparatus 200 (hereinafter, also referred to as a vehicle B black box 200) mounted in a vehicle B.

Each of the vehicle A black box 100 and the vehicle B black box 200 may have a configuration same as or similar to the configuration of FIG. 2.

For example, referring to FIG. 2, the vehicle A black box 100 may include the camera module 101, the storage unit 104, the communication unit 107, the controller 107, and a warning unit 150.

For example, referring to FIG. 2, the vehicle B black box 200 may include a camera module 201, a storage unit 204, a communication unit 205, a controller 207, and a warning unit 250.

The camera modules 101 and 201 may convert, to an image, light input through a photographing device, for example, a charge coupled device (CCD) or a complementary metal-oxide semiconductor (CMOS), and may output the converted image to the controllers 107 and 207, respectively. The controllers 107 and 207 may generate a danger signal by analyzing an object included in image data based on a predetermined standard.

According to an embodiment of the present invention, when a danger signal is generated, the controller 107 of the vehicle A black box 100 may warn a driver of a corresponding vehicle, for example, the vehicle A through the warning unit 150 and may also provide a warning signal to a driver of another vehicle, for example, the vehicle B through the vehicle B black box 200 by transmitting the danger signal to the other vehicle through the communication unit 105.

A driver may be informed, for example, alert using an external display device of a black box, a sound output, and a control of a lighting such as a headlight and a tail lamp.

Hereinafter a method of analyzing an image and transmitting a danger signal to a driver of another vehicle will be described.

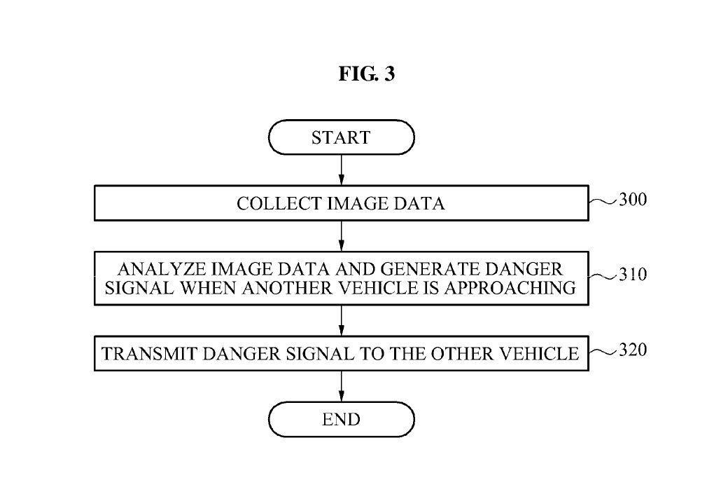

FIG. 3 is a flowchart illustrating a method of providing information according to an embodiment of the present invention. The information providing method of FIG. 3 may be performed by the vehicular image processing apparatus 100 and the vehicular image processing system described with reference to FIGS. 1 and 2. Hereinafter, the information providing method according to the present embodiment and operations of the vehicular image processing apparatus 100 and the vehicular image processing system to carry out the information providing method will be described with reference to the accompanying drawings.

Referring to FIG. 3, the controller 107 of the vehicle A black box 100 may collect image data in operation 300, may analyze image data and generate a danger signal when another vehicle is approaching in operation 310, and may warn a driver of the other vehicle about the danger of accident through communication when the other vehicle is approaching within a predetermined distance in operation 320.

The vehicle A black box 100 may capture an image using the camera module 101 in operation 300, and may generate a danger signal by analyzing the captured image in operation 310.

According to an embodiment of the present invention, the vehicle A black box 100 may recognize a relative object, for example, another vehicle by analyzing image data and may determine whether to generate the danger signal based on a distance from the relative object and a direction of the relative object.

In operation 320, the vehicle A black box 100 may inform, for example, warn the driver of the other vehicle about the danger of accident through communication with the relative vehicle. A communication scheme used to inform the driver of the other vehicle may include a near field communication scheme, an infrastructure based warning communication scheme, and a vehicle-to-vehicle communication scheme.

When a plurality of vehicles is present around the vehicle A, a process of connecting to a communication unit of another vehicle corresponding to a counterparty vehicle may be required to warn only a driver of the other vehicle that provides a danger factor among the plurality of vehicles.

For example, the vehicle A black box 100 may connect to another vehicle travelling, for example, being driven at a corresponding location by analyzing a location of the other vehicle that appears in an image of the vehicle A black box 100 based on location information of the corresponding vehicle and by transmitting location information and a communication connection request signal to peripheral vehicles.

For example, the vehicle A black box 100 may connect to another vehicle by recognizing a plate number of the other vehicle and by transmitting plate number information and a communication connection request signal.

Hereinafter, a method of generating a danger signal based on a distance with another vehicle will be described.

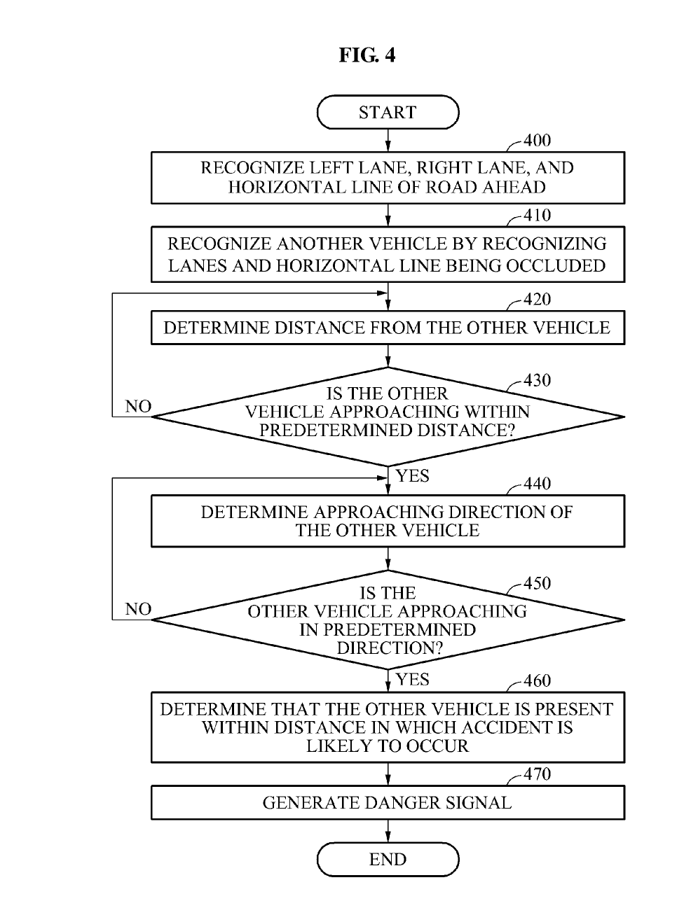

FIG. 4 is a flowchart illustrating a method of providing information according to another embodiment of the present invention. The information providing method of FIG. 4 may be performed by the vehicular image processing apparatus 100 and the vehicular image processing system described with reference to FIGS. 1 and 2. Hereinafter, the information providing method according to the present embodiment and operations of the vehicular image processing apparatus 100 and the vehicular image processing system to carry out the information providing method will be described with reference to the accompanying drawings.

The information providing method of FIG. 4 may correspond to an example of generating a danger signal in operation 310.

Referring to FIG. 4, the controller 107 of the vehicle A black box 100 may recognize a left lane, a right lane, and a horizontal line of a road ahead in operation 400, may recognize another vehicle based on the recognized lanes and horizontal line being occluded in operation 410, and may determine a distance from the other vehicle in operation 420.

When the determined distance from the other vehicle is within a predetermined distance, that is, when the other vehicle is approaching within the predetermined distance in operation 430, the controller 107 of the vehicle A black box 100 may determine an approaching direction of the other vehicle in operation 440 and may also determine whether the other vehicle is approaching in a predetermined direction in operation 450.

When the other vehicle is approaching in the determined direction, the controller 107 of the vehicle A black box 100 may determine that the other vehicle is present within a distance in which an accident such as a collision is likely to occur in operation 460 and may generate a danger signal in operation 470.

Hereinafter, an image recognition algorithm will be described.

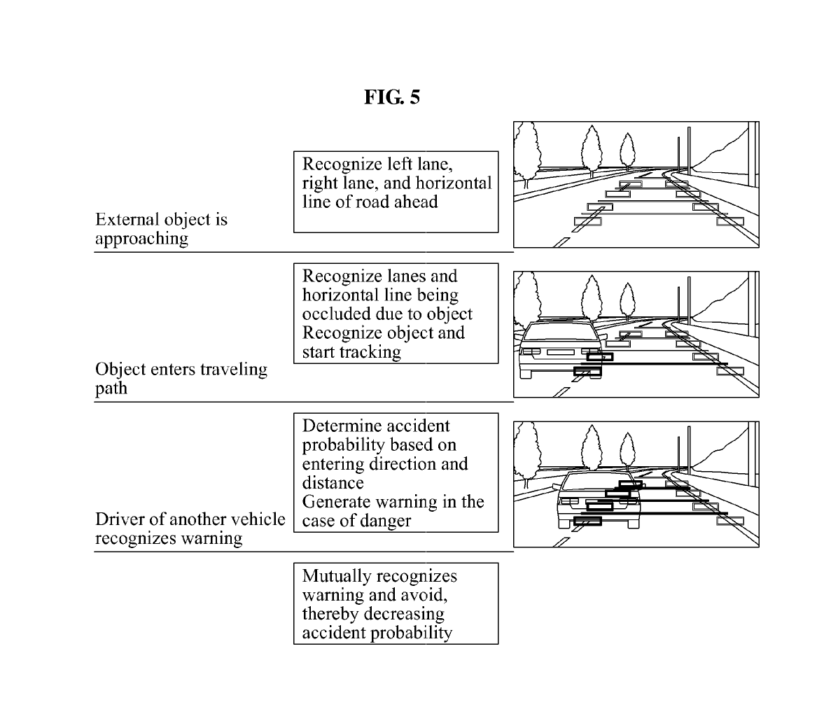

FIG. 5 illustrates an example of applying image recognition according to an embodiment of the present invention.

According to an embodiment of the present invention, referring to FIG. 5, it is possible to detect, from an image of the vehicle A black box 100, a left lane, a right lane of the corresponding vehicle being driven, and a horizontal line of a road ahead, and to detect an approaching object.

In a case in which an external object is approaching the corresponding vehicle, a lane or a horizontal line may be occluded due to the object and thus, the object may be detected and tracked.

In a case in which an object is entering a travelling direction of the corresponding vehicle or approaching within a predetermined distance, an accident probability may be determined to be high and thus, a warning may be output.

In a case in which the vehicle A black bock 100 determines a speed of the corresponding vehicle and a peripheral circumstance and, as a result, entering of an object is caused due to sudden acceleration of the corresponding vehicle or a sudden control of a handle, the vehicle A black bock 100 may transmit a warning to a driver of the corresponding vehicle.

In a case in which the vehicle A black bock 100 determines a speed of the corresponding vehicle and a peripheral circumstance and, as a result, the corresponding vehicle is being safely driven at a speed similar to other vehicles and a predetermined vehicle or object is approaching the corresponding vehicle due to sudden acceleration or deceleration, or a sudden control of a handle, the vehicle A black bock 100 may transmit a warning to a driver of the approaching predetermined vehicle or object.

Hereinafter, an example of receiving peripheral vehicle information through an infrastructure will be described.

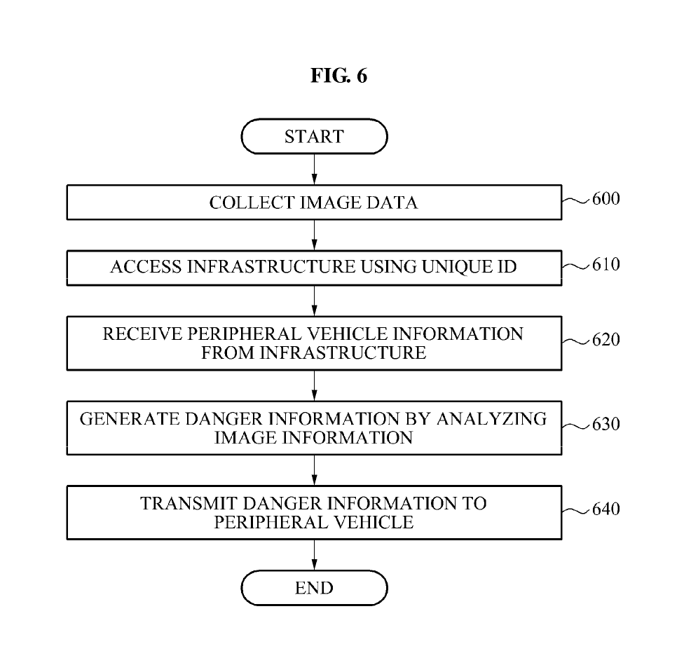

FIG. 6 is a flowchart illustrating a method of providing information according to still another embodiment of the present invention. The information providing method of FIG. 6 may be performed by the vehicular image processing apparatus 100 and the vehicular image processing system described with reference to FIGS. 1 and 2. Hereinafter, the information providing method according to the present embodiment and operations of the vehicular image processing apparatus 100 and the vehicular image processing system to carry out the information providing method will be described with reference to the accompanying drawings.

Referring to FIG. 6, the controller 107 of the vehicle A black box 100 may collect image data in operation 600, may access an infrastructure using a unique ID in operation 610, may receive peripheral vehicle information from the infrastructure side in operation 620, may generate danger information of a peripheral vehicle by analyzing image information in operation 630, and may transmit the generated peripheral information to the peripheral vehicle in operation 640.

The infrastructure may be a closed circuit television (CCTV) provided around or another black box manufactured by the same manufacturing company.

The peripheral vehicle information received from the infrastructure may include a plate number of the peripheral vehicle and an address or an ID of a communication unit used for connection to the communication unit.

Danger information may be directly transmitted to the peripheral vehicle using a method of transmitting danger information to a peripheral vehicle, for example, using the vehicle A black box 100. As another example, when the vehicle A black box 100 transmits danger information to the infrastructure, the infrastructure may transmit the danger information to a predetermined peripheral vehicle or all the peripheral vehicles using a broadcasting method.

Hereinafter, an infrastructure based warning scheme will be described.

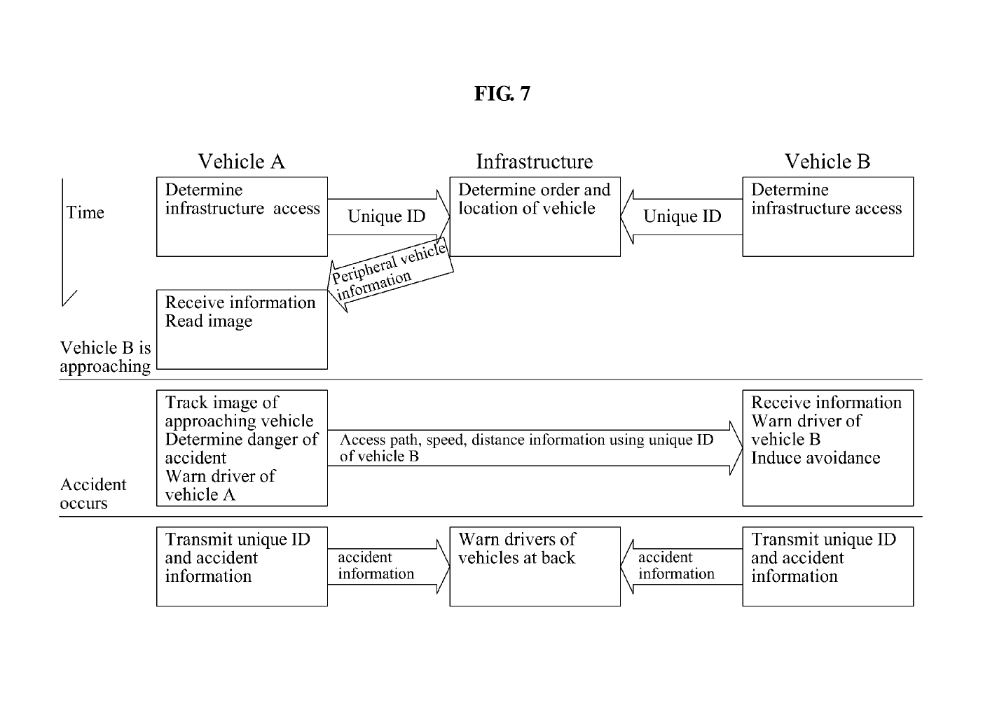

FIG. 7 is a diagram illustrating an infrastructure based warning scheme according to an embodiment of the present invention.

A distance between vehicles and an approaching direction may be transmitted and received using wireless near field communication between the vehicles having a warning function. In a case in which another vehicle corresponding to a counterparty vehicle receives a warning, it is possible to enable a driver of the other vehicle to avoid danger by warning the driver of the other vehicle about the approaching direction and the inter-vehicle distance.

Referring to FIG. 7, a warning may be transmitted to the other vehicle through the infrastructure based communication.

As an infrastructure communication method such as a commercialized high-pass terminal, a dedicated short range communication (DSRC) service that is short range/low power data communication technology may be employed.

During driving, a black box apparatus may access an infrastructure and may inform the infrastructure about its unique ID. The infrastructure fixed at a predetermined interval on a road may receive the unique ID, may determine driving order of vehicles on the road, and may transfer unique IDs of peripheral vehicles present at the front, rear, and side of a corresponding vehicle to individual vehicles.

The black box may receive information including a unique ID of a peripheral vehicle. When the black box determines that an accident is likely to occur as a result of analyzing an image, the black box may transfer warning data to a corresponding vehicle among received unique IDs.

In a case in which an accident occurs, the black box may inform the infrastructure of the accident so that the infrastructure may broadcast the occurrence of accident to vehicles being driven at the back.

Hereinafter, a vehicle-to-vehicle communication based warning communication scheme will be described.

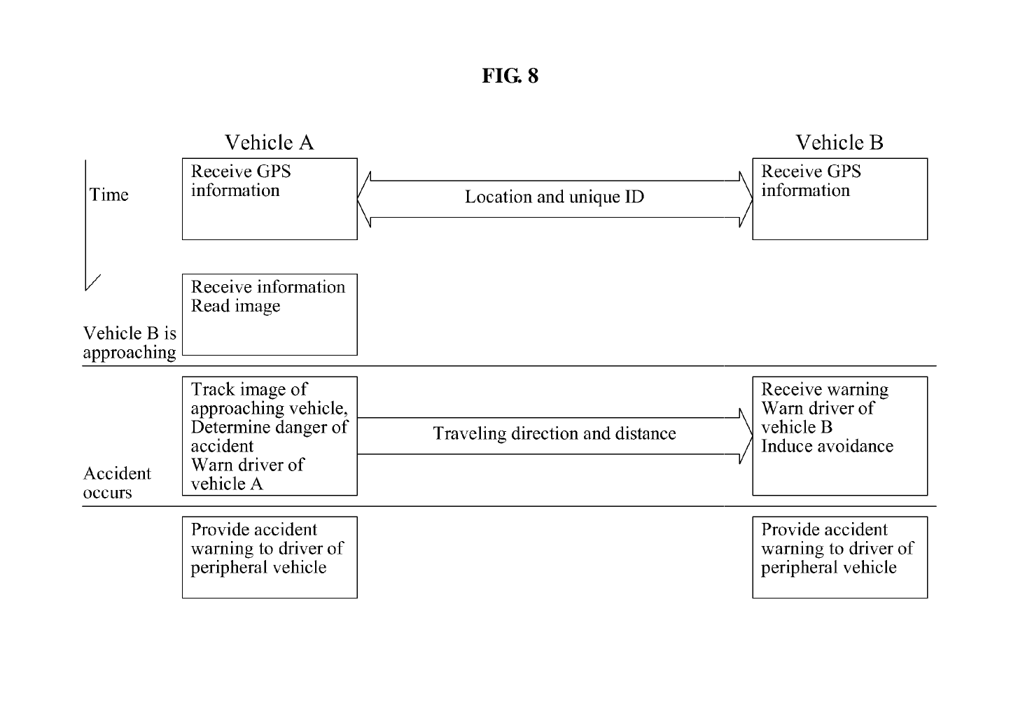

FIG. 8 is a diagram illustrating a vehicle-to-vehicle communication based warning scheme according to an embodiment of the present invention.

Referring to FIG. 8, unique ID and current vehicle location information may be exchanged between a corresponding vehicle and peripheral vehicles being driven through vehicle-to-vehicle communication such as CAR2X.

A black box may compare a received location of another vehicle and a current location of the corresponding vehicle in which the black box is mounted and thereby determine a location of the other vehicle. In a case in which the danger of accident is present, for example, in a case in which an accident is likely to occur, the black box may transmit a warning to a vehicle of a unique ID corresponding to the corresponding location. Whether the danger of accident is present may be determined based on approaching of the other vehicle by a travelling direction of the other vehicle or a distance therefrom.

In a case in which communication between vehicles is impossible, a warning may be performed using lighting and sound. In a vehicle in which a warning device is not mounted or in a state in which communication is impossible, a warning may be directly provided to a driver of the other vehicle in conjunction with a headlight of the corresponding vehicle, a flash embedded within the black box, a horn, and the like

A vehicular image processing apparatus and a method of providing information using the vehicular image processing apparatus according to embodiments of the present invention may achieve the following effects.

According to embodiments of the present invention, it is possible to recognize a danger of accident and simultaneously warn a driver of a corresponding vehicle and a driver of another vehicle corresponding to a counterparty vehicle. Accordingly, mutual avoidance is enabled and an accident occurrence probability may be further decreased.

Also, according to embodiments of the present invention, it is possible to prevent a secondary accident by warning surroundings about the occurrence of accident through near field communication.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A vehicular image processing apparatus mountable in a vehicle, the vehicular image processing apparatus comprising:
a camera module configured to acquire an external image; and
a controller configured to analyze the external image, and to transmit a danger signal to an outside of the vehicle when a danger associated with a predetermined object present outside the vehicle is determined to be present.

2. The vehicular image processing apparatus of claim 1, wherein the controller is configured to determine whether the danger associated with the predetermined object is present, based on a result of recognizing a lane comprised in the external image.

3. The vehicular image processing apparatus of claim 1, wherein the controller is configured to recognize, from the external image, at least one of a left lane, a right lane, and a horizontal line of a road ahead that connects the left lane and the right lane.

4. The vehicular image processing apparatus of claim 3, wherein the controller is configured to determine whether the predetermined object is to enter ahead of the vehicle, based on whether at least one of the left lane, the right lane, and the horizontal lane recognized from the external image is occluded by the predetermined object.

5. The vehicular image processing apparatus of claim 4, wherein the controller is configured to determine a distance between the predetermined object and the vehicle when the predetermined object is determined to enter ahead of the vehicle.

6. The vehicular image processing apparatus of claim 5, wherein the controller is configured to determine that the danger associated with the predetermined object is present when the distance between the predetermined object and the vehicle is less than a predetermined threshold.

7. The vehicular image processing apparatus of claim 5, wherein the controller is configured to determine an approaching direction of the predetermined object, and to determine whether the danger associated with the predetermined object is present based on the determined approaching direction of the predetermined object and the distance between the predetermined object and the vehicle.

8. The vehicular image processing apparatus of claim 1, wherein the controller is configured to determine whether the danger associated with the predetermined object is present by recognizing whether the predetermined object comprised in the external image is approaching the vehicle.

9. The vehicular image processing apparatus of claim 1, further comprising:
a communication unit configured to communicate with the predetermined object,
wherein the controller is configured to control the communication unit to transmit the danger signal to the predetermined object.

10. The vehicular image processing apparatus of claim 9, wherein the controller is configured to analyze location information of the vehicle and a location of the predetermined object determined from the external image, and to control the communication unit to transmit the location information and a communication connection request signal to the outside.

11. The vehicular image processing apparatus of claim 9, wherein the controller is configured to control the communication unit to transmit, to the outside, a communication connection request signal and identification information of the predetermined object determined from the external image.

12. The vehicular image processing apparatus of claim 1, wherein the controller is configured to transmit the danger signal to a plurality of objects present around the vehicle.

13. The vehicular image processing apparatus of claim 1, further comprising:
a warning unit configured to indicate the danger signal inside the vehicle.

14. The vehicular image processing apparatus of claim 1, wherein the danger signal comprises at least one of a warning signal, a lighting tool, and a sound output that is transmitted to the predetermined object or a peripheral vehicle of the vehicle.

15. The vehicular image processing apparatus of claim 1, wherein the controller is configured to receive information on at least one object present around the vehicle through an infrastructure provided around a road, and to transmit the danger signal to the at least one object based on the received information.

16. A method of providing information using a vehicular image processing apparatus mountable in a vehicle, the method comprising:
acquiring an external image about an outside of the vehicle;
determining whether a danger associated with a predetermined object present outside the vehicle is present by analyzing the external image; and
transmitting a danger signal to the outside of the vehicle when the danger associated with the predetermined object is determined to be present.

17. The method of claim 16, wherein the determining comprises determining whether the danger associated with the predetermined object is present by recognizing a lane comprised in the external image.

18. The method of claim 16, wherein the determining comprises determining whether the danger associated with the predetermined object is present by recognizing whether the predetermined object comprised in the external image is approaching the vehicle.

19. The method of claim 16, wherein the transmitting comprises transmitting the danger signal to a plurality of objects present around the vehicle.

20. The method of claim 19, wherein the transmitting comprises receiving information on the plurality of objects through an infrastructure provided around a road, and transmitting the danger signal to the plurality of objects based on the received information.
